(19) United States
(12) Patent Application Publication
(10) Pub. No.: US 2006/0287876 A1
(43) Pub. Date: Dec. 21, 2006

(54) Computer system and method for assessing family structures using affinographs

(76) Inventor: Davor Jedlicka, Tyler, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/157,087

(22) Filed: Jun. 20, 2005

(51) Int. Cl. G06Q 99/00

(52) U.S. Cl. 705/1

(57) ABSTRACT

A method and computer program for graphically representing and assessing modern family structures. A plurality of family relationship objects are graphically represented on a graph. Each family relationship includes one or more person objects representing family members. Each family relationship object is graphically connected to one or more other family relationship objects. Each family relationship connection connects two family relationship objects and includes a person object that is common to the two family relationship objects. Each family relationship connection is a non-hierarchical graphical representation of at least one of an intergenerational family connection and a intragenerational family connection.

### BACKGROUND OF THE INVENTION

The present invention relates to graph theory and more particularly to a computer system and method for assessing family structures where traditional marriage and mate selection are possibilities in a wide range of stable and dynamic family structures.

### DISCUSSION OF THE BACKGROUND

If a picture is worth a thousand words, graphic representations of families can be quite revealing. That may be why people have been doing visual images in the form of family trees since ninth century. A thousand years later Henry Lewis Morgan and Macfarlane introduced images that anticipated the pictures produced by network analysts using graph theory.

Traditional Graphic Representations of Families

Early in the 20th century, graphic representations of families emerged within the tradition of Mendelian genetics. Mendelian graphs or family trees have been central in family systems theory and clinical practice where family trees are also known as “genograms.” Genograms have been successfully used to track family members cut off across generations and to assess family structures in clinical settings. These assessment genograms are also known as “systemic maps.”

Genograms are a version of the family trees, the oldest method of visualizing families. At the turn of the 20th century, the use of family trees was expanded to include studies of marriage customs, boundaries of totemism, and demographic characteristics of marriage partners. Such family representations have been described as pedigrees focused on an individual, whereby the social condition of each person included in the pedigree is recorded as far as possible.

Relationships, family trees or genograms are represented using a known set of symbols. For instance, the position of words and their capitalization are typically used to represent gender and relations. The husband's name is typically to the left of the wife and male names are typically capitalized. Brackets are typically used to identify spouses in polygynous or polyandrous marriages. Squares, circles and triangles have typically been used to represent persons. In the fields of psychiatry, social work, and family therapy, a square is typically used to represent a male and a circle is typically used to represent a female in pedigrees. The square and the circle are connected either by a straight horizontal line or a bracket. These symbols and the convention of listing the male to the left of the female are used in clinical assessment of families. In the fields of anthropology and sociology, an equal sign is typically used to indicate a marriage and a triangle, instead of a square, is typically used to represent a male.

Unfortunately, family trees and genograms are limited to representing traditional family structures and are incapable of mapping the more complicated family configurations resulting from serial marriages and other nonconventional associations. Family trees and genograms are designed for traditional rules of marriage and are based on traditional assumptions including, but not limited to, those shown in TABLE 1.

TABLE 1
TRADITIONAL ASSUMPTIONS

| | |
|---|---|
| 1. | Marriage removes participants permanently from the field of those |
| | eligible to enter into a relationship. |
| 2. | Remarriage involves mainly widows and widowers. |
| 3. | Procreation takes place in stable, monogamous or polygamous |
| | families. |
| 4. | Committed, intimate relationships are heterosexual. |
| 5. | Every person has exactly one father and one mother. |

By the 1970s, sociologists had already forecast changes in the American family that would make these traditional assumptions obsolete. Sociologists identified that being married does not restrict the availability for remarriage and that, instead, there existed trends toward a “permanent availability” of partners. By the 1990s, serial monogamy with or without marriage had become much more common. Childbearing without marriage has also increased in prevalence. Even as mate selection rules and the family structure changed, the representational techniques developed a century earlier persisted unchanged. These antiquated representational techniques are poorly suited for the representation of modern family structures.

Although attempts have been made to supplant these antiquated techniques, these attempts have failed to fully address the complex problems associated with the modern family structure. For instance, in 2001, a graphic representation called “p-systems” or “p-graphs” was proposed to represent complex structures such as the modern family structure. The p-graph was designed to graphically represent social networks that include kinship and marriage ties using two types of vertices. One type of vertex represents organizations: families, business, or other groups to which individuals belong. The other type of vertex represents an individual and a linkage between this individual and a group. This second type of vertex exemplifies the defining feature of p-graphs: it has a maximum outdegree of two directed arcs, and the relation between vertices defined by these arcs is one of strict (temporal) order. The first type of arc is constrained by definition to these same conditions. Hence, the p-graph is asymmetric and acyclic and generates a partial ordering among the vertices. Further, the p-graph is founded on the traditional assumptions rooted in the bloodline genealogy and fails to differentiate between intragenerational changes in intimate linkages due to divorce, remarriage, cohabitation, out-of-wedlock childbearing with serial partners with or without marriage. Therefore, modern departures in family forms are extremely difficult and/or impossible to represent using p-graphs. Likewise, p-graphs have no apparent utility for social workers, therapists and others who need clear visual images of family relations. Finally, p-graphs include redundant information: the same person is represented by a line and a node in the same network.

Thus, there exists a need for a graph theory for assessing modern family structure that minimizes the cultural or personal biases and assumptions associated with relationships, family trees or genograms.

### SUMMARY OF THE INVENTION

Accordingly, one object of the present invention is to provide a computer system for graphically representing modern family structures. The computer system includes one or more processors, and a computer readable medium connected to the processors. The computer readable medium includes processor instructions configured to be read by the processors and thereby cause the processors to graphically represent a plurality of family relationship objects and graphically connect each family relationship object to one or more other family relationship objects. Each family relationship includes one or more person objects representing family members. Each family relationship connection connects two family relationship objects and includes a person object that is common to the two family relationship objects. Each family relationship connection is a non-hierarchical graphical representation of at least one of an intergenerational family connection and a intragenerational family connection.

Another object of the present invention is to provide a method for assessing modern family structures that includes graphically representing a plurality of family relationship objects and graphically connecting each family relationship object to one or more other family relationship objects. Each family relationship includes one or more person objects representing family members. Each family relationship connection connects two family relationship objects and includes a person object that is common to the two family relationship objects. Each family relationship connection is a non-hierarchical graphical representation of at least one of an intergenerational family connection and a intragenerational family connection.

Yet another object of the present invention is to provide a method for an improved family tree including graphically adding a plurality of family relationship objects to a family tree and graphically connecting each family relationship object to one or more other family relationship objects. Each family relationship includes one or more person objects representing family members. Each family relationship addition represents a linear growth to the family tree. Each family relationship connection connects two family relationship objects and includes a person object that is common to the two family relationship objects. Each family relationship connection is a non-hierarchical graphical representation of at least one of an intergenerational family connection and a intragenerational family connection.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 graphically depicts symbols used in affinographs according to an embodiment of the present invention;

FIG. 2 graphically depicts an exemplary affinograph of a “single parent family” according to an embodiment of the present invention; 100161 FIG. 3 graphically depicts an exemplary affinograph of a “blended family” according to an embodiment of the present invention;

FIG. 4 graphically depicts an exemplary affinograph illustrating intergenerational lineage according to an embodiment of the present invention;

FIG. 5 graphically depicts an exemplary affinograph as an improved family tree according to an embodiment of the present invention;

FIG. 6 graphically depicts an exemplary affinograph as an improved family tree according to an alternate embodiment of the present invention; and

FIG. 7 is a flow chart generally illustrating a method of graphically representing an affinograph according to an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention graphically represents modern family structures, such as those assessed in clinical settings, using a new type of graph referred to as an “affinograph.” The prefix “affino” signifies “affinity and consanguillity.” The word “graph” signifies that the affinograph conforms to the axioms of graph theory as shown in TABLE 2.

TABLE 2
AXIOMS OF GRAPH THEORY

| | |
|---|---|
| 1. | The number of points in the network is finite and greater than zero. |
| 2. | The number of lines are finite. |
| 3. | Each line originates in a point and ends in a point. |
| 4. | There are no loops. |
| 5. | The maximum number of incoming directed lines per point is equal to |
| | or smaller than the number of out-coming directed lines. |

Unlike the prior art, an affinograph represents a modern family structure, whereby all vertices represent relations and each line represents a person. The formal procedure for converting relations into vertices is known as condensation. Lines can be dotted or solid to indicate the gender of a person involved in changing relations. An affinograph precludes axiomatically a person from being its own vertex. The axioms of the graph theory set the parameters of the model, thereby minimizing the cultural and personal biases and assumptions. The reduction of biases is required to develop a model based on gender neutral and culture-free assumptions.

I. Assumptions Underlying an Affinograph Model

Each representational model of families encompasses some assumptions. Sometimes those assumptions are not explicit and other times assumptions of the observer conflict with the reality from the point of view of the observed. As shown in TABLE 3, the affinograph assumptions attempt to minimize the common cultural and personal biases and assumptions. For instance, the first affinograph assumption avoids the bias toward the longevity of a relationship.

TABLE 3
AFFINOGRAPH ASSUMPTIONS

| | |
|---|---|
| 1. | Affilial relations vary in stability from ephemeral to life-long. |
| 2. | Married people may remain in the field of those eligible to enter into |
| | a relationship for life. |
| 3. | Families are formed with or without marriage. |
| 4. | Relationship commitment is gender neutral. |
| 5. | Each person has as many parents as that person identifies through |
| | expenence. |

It is generally accepted that a relation between a significant other and a child makes a parent regardless of bloodlines. In the prior art, family trees accentuate the bloodlines represented in a hierarchical structure. Said another way, a family tree identifies the family of origin by its position above the family of procreation. Unlike the prior art, the affinograph model represents intragenerational and intergenerational connections without a hierarchy. The assumption is that biological and affilial parents can be psychologically significant to a child.

These assumptions encompass traditional and non-traditional families. Strict monogamy, serial monogamy, same gender relations, or even polygamy can be represented and assessed without an apparent bias toward any form of relationship. Symbols used to represent family structures under these assumptions tend to be parsimonious.

II. Graphically Representing an Affinograph

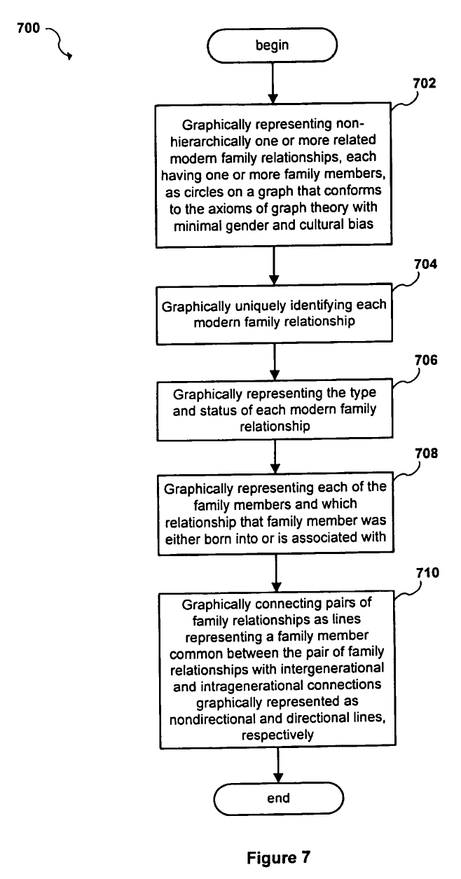

Referring to FIG. 7, a flow chart generally illustrating a method of graphically representing an affinograph according to an embodiment of the present invention is shown. At block 702, one or more related modern family relationships are graphically represented non-hierarchically on a graph that conforms to the axioms of graph theory, as shown in TABLE 2, with minimal gender and cultural bias. Each modern relationship has one or more family members.

At block 704, each modern family relationship is graphically identified with a unique identifier. The type and status of each modern family relationship is graphically represented at block 706.

At block 708, each of the family members are graphically represented. Which relationship each family member was either born into or is associated with is also graphically represented.

At block 710, the family relationships are graphically connected as lines representing a family member that is common between the respective family relationship pair. Intergenerational and intragenerational connections are distinctly represented with nondirectional and directional lines, respectively.

III. Symbols Used in Affinograph Construction

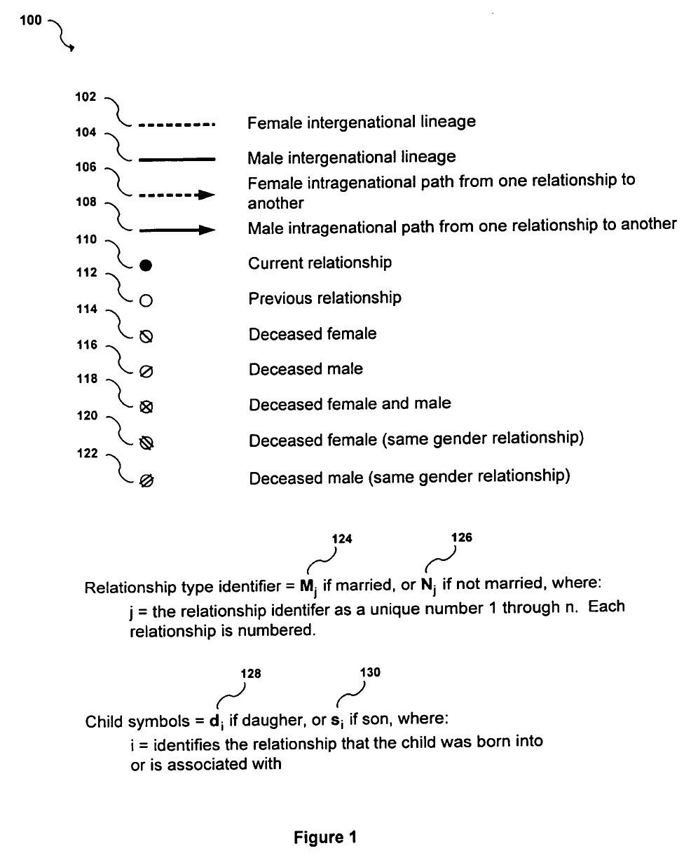

Referring to FIG. 1, a graphical depiction of the symbols used in affinographs according to an embodiment of the present invention is shown. Two basic symbols used in an affinograph are circles and lines. Circles (110-122) are used instead of points for a heuristic reason: a circle can be filled or unfilled. An unfilled circle 112 indicates a past relation and a filled circle 110 indicates a current relation. A slash slanted left through the circle 114 indicates a relationship that ended through the death of a female. A slash slanted right through the circle 116 indicates that the relationship ended through the death of a male. If both partners were of the same gender, the slashes through the circle would be parallel (120 and 122).

Directed and undirected lines (102-108) in an affinograph represent a person's connection between two relationships. A dotted line (102 and 106) is used to represent a female and a solid line (104 and 108) is used to represent a male. A line can be directed (106 and 108), as indicated with an arrow, or undirected (102 and 104). Each undirected line (102 and 104) represents an intergenerational connection between two generations. Each directed line (106 and 108) represents an intragenerational connection between a past and present relationship within the same generation.

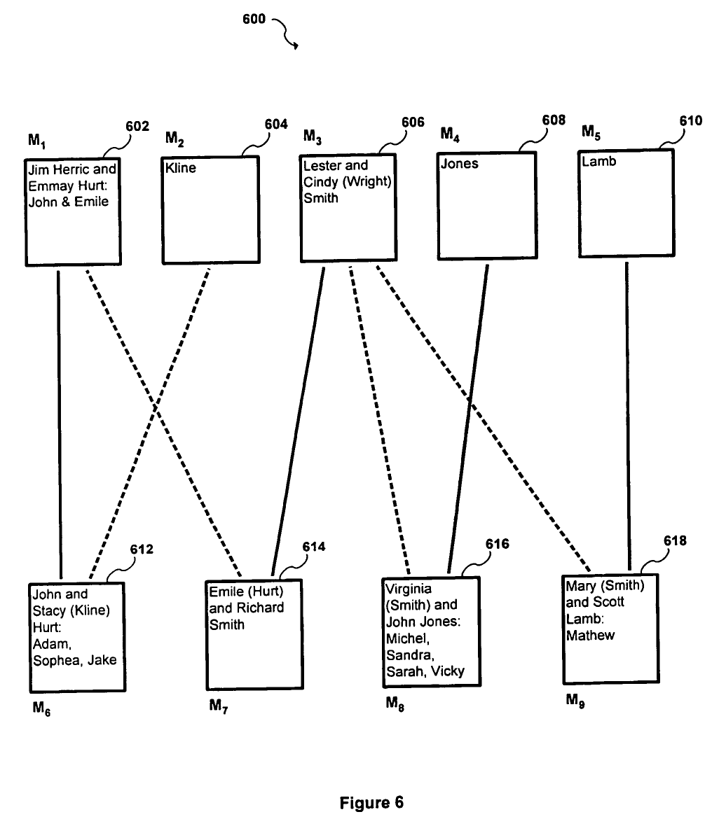

The graphical depiction of symbols are not limited to those symbols as shown in FIG. 1 and other configurations are possible within the scope of the present invention. For instance, FIG. 6 uses squares instead of circles to represent relationships.

In one embodiment, affinographs are used to represent an individual's perceptions regarding his/her family structure for each of that person's family members. That person's perceptions define the type of relationship associated with each circle used in the affinograph. Each relationship has a relationship type identifier, such as an alphabetic letter. In one embodiment, the letters “M” and “N” may be used to represent relationships involving married persons 124 and non-married persons 126, respectively. After a participant identifies a relationship type, the relationship type identifier is used to label the circle. The circles themselves only indicate that there is a relationship. The relationship type identifier can take any value without changing the structure or the symbols in the graph. The meaning of the relation can be obtained from the individual being observed or from the point of view of an observer. The relationship type identifier is not limited to the letters “M” and “N” and other configurations are possible within the scope of the present invention.

Each relation also has a unique relationship identifier. The relationship identifier uniquely identifies each relationship and serves as an anchor to track children, or optionally other family members, from their births to their current locations in the affinograph. In one embodiment, the relationship identifier is graphically represented as a unique numeric subscript of the relationship type identifier (124 and 126). The relationship identifier is not limited to a numeric subscript and other configurations are possible within the scope of the present invention.

IV. Tracking Children Using Affinographs

Each relation may also have one or more child symbols that are used to identify the locations of children in relation to their parents. In one embodiment, the letters “d” and “s” are used to represent a daughter 128 and son 130, respectively. Each child symbol (128 and 130) may have a child relationship identifier, similar to the relationship identifier associated with each relationship. The child relationship identifier uniquely identifies which relationship the child was either born into or is associated with (e.g., formal or informal adoptions). The child symbols are not limited to the letters “d” and “s” and other configurations are possible within the scope of the present invention. Addititionally, other letters and/or symbols may optionally be used to represent other family members.

Optionally, a birth order indicator, such as a unique number, may be associated with each child symbol, representing the birth order of all children in one relationship. Birth order indicators allow for the representation of multiple births and at a glance one can see when a child was born. For instance, two children with the same birth order indicators, indicates that they were born at the same time (e.g., twins). Each child is represented in the most recent relation only. The graphic representation of a path from the relationship at birth to the current relationship of each child is a feature of the affinograph called “tracking.”

Tracking children and their parents in complex family networks is a challenge for those who provide services to families. While the prior art techniques of graphic representations of families may have been acceptable in traditional family structures in which parents did not change partners and the rules of residence for children were predictable, they do not work well in the United States at the turn of the 21st century when such is often not the case. Children and parents change households to the bewilderment of social workers who sometimes lose track of children entrusted to their supervision. Tracking problems could be minimized if the official files contained social network information associated with each child. An affinograph at a glance reveals who is most likely to know where the children or other family members are located.

As an example of the tracking procedure used in conjunction with an affinograph, consider a married couple M. Living with this couple are children that each spouse brought from previous relationships. One spouse had a son and a daughter, and the other spouse had a daughter. Each child has a biological parent and a step parent in the current relationship, and a biological parent elsewhere. This hypothetical relationship may be expressed symbolically as:
Mⱼ(s, d)ᵢ_{₁}(d)ᵢ_{₂}

where the letters “i₁” and “i₂” signify the child relationship identifier (e.g., a number) of the relationship in which each child was born and the letter “j” signifies the relationship identifier of the current relationship. In this case, the relationship type identifier is the letter “M,” representing a married relationship. The letters “d” and “s” are used to represent a son and a daughter, respectively, from each spouse's previous relationships. In this example, the value of the relationship identifier (j) in the current relationship is different from the values of “i₁” or “i₂.” However, if there were children born in the current relationship, then the value of the relationship identifier (j) would be equal to the value(s) of the child relationship identifiers (i₁, . . . , iₙ) for each of those children.

There are many ways to lose track of children entrusted to social agencies including, but not limited to, inadequate record keeping. Because official records typically focus a single individual within a single household, when that person changes household the social agency is likely to lose track. Losing track of children is far more common than most people realize. Further, this problem can not even be quantified, because no records are kept indicating exactly how many children are lost. Home-schooled children, abused children, and children who fail to attend school disappear from the system without a record of their disappearance. Typically, only when some dreadful thing happens to them does their disappearance become known publicly.

The affinograph is designed to make accountability and tracking of family members easier. Families that come to the attention of the authorities tend to have complicated constellations spread across multiple households possibly located in different cities, counties, and even states. The affinograph connects these family constellations graphically as easily as a traditional family tree connects generations. With the aid of a computer or other electronic device, contact information on each relevant significant party in the past and the present may be included in the permanent record. Thereby, when one or more of the children change residence, the contact information and quick overview of the entire family constellation could help locate a child who today might become lost, abused and/or uneducated.

V. Tracking Members of a Single Parent Family

Many families are headed by a single parent, commonly referred to as a “single parent family.” Many of these families are involved with family members beyond one household. Significant others include extended kin, biological parents living elsewhere, new sexual partners of the live-in parent, surviving partners of a deceased parent, or living partners of an absent parent.

Which relationships are important to an individual must typically be determined on a case by case basis. For some children, the geographic distance from another parent may not diminish the attachment. Other children may have close relations with grandparents who live elsewhere. A parent's past and present partners may also be a part of a child's perceived family network. As such, rather than being a “single parent family,” each family may have emotional ties, negative or positive, outside the immediate household. However, the institutions entrusted to aid families have in the past often had a clear and invariable model of operation: one case equals one person no matter how complex the family structure. Each file only has one individual's name associated with the file (“Client”), usually a child's name. The genograms for each case are simple because they are restricted to related members living in that household. Even the biological parent, if not living within a household, would not be included in any therapeutic processes associated with the aid of the family.

In one embodiment, during clinical assessment of families, conventional informal notes along with an affinograph are used. Any informal notes are organized around the affinograph constructed from the Client's point of view. The affinograph allows a user to quickly note each relation that the Client identifies as being relevant in the past and present.

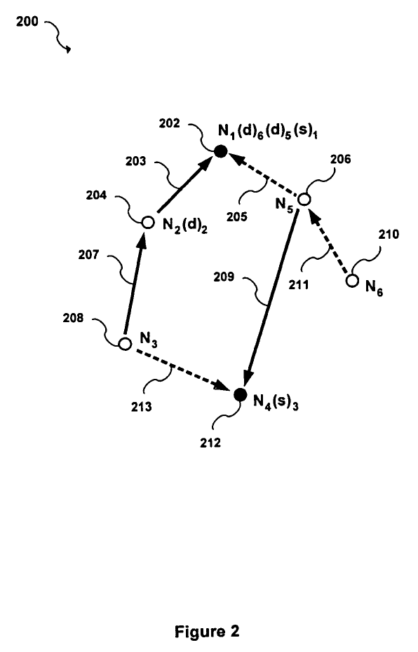

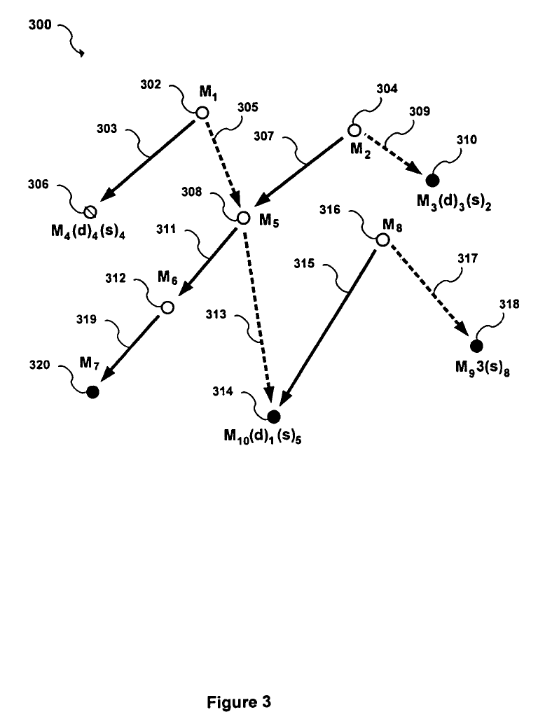

Referring to FIG. 2, a graphical depiction of an exemplary affinograph of a “single parent family” according to an embodiment of the present invention is shown. This hypothetical family structure 200 is graphically represented from a 17-year-old girl's (“Daughter”) perspective. Daughter is the child of an unmarried mother (“Mother”). The Daughter has a 12-year-old half-sister and a 3-year-old half-brother. Each of the three siblings in this household has the same mother, but a different father. The father of the three-year-old boy (“Live-in Partner”) also lives with them. The Live-in Partner has two other children with two different mothers living in two other households. One of these mothers has a second child with a man who was the father of the 12-year-old half-sister. The affinograph makes it possible to assess the relevant relations in the family structure and to track them over time even where there may be ten or more families with equally complicated constellations. In this hypothetical family structure 200 no one was ever married. Therefore, the graphical depiction of the hypothetical family structure 200 uses the letter “N” to indicate non-marital relations, as shown in FIG. 2.

In this hypothetical family structure 200, the filled circle labeled as “N₁(d)₆,(d)₅(s)₁” represents a current unmarried relationship (focal household) 202 of Mother and Live-in Partner and includes three children. The three children include the 17-year-old Daughter (d)₆, a 12-year-old half-sister (d)₅, and a 3-year-old half-brother (s)₁. The different fathers for children are indicated by different child relationship identifiers, shown as subscripts 6, 5 and 1, respectively, after each child. In this case, the 3-year-old half-brother (s)₁ is shown as the son of both parents of the focal household N₁ by the values of the child relationship identifier and the relationship identifier, respectively, associated with the 3-year-old half-brother (s)₁ and the focal household N₁, both being equal to 1. The filled circle indicates that the relationship 202 is a current relationship from the Daughter's perspective.

As shown at 204, the unfilled circle labeled as “N₂(d)₂” represents a previous unmarried relationship of Live-in Partner and another woman outside the focal household. This previous relationship 204 includes a mother and the Live-in Partner's daughter (d)₂. As shown at 208, the unfilled circle labeled as “N₃” also represents a previous unmarried relationship of Live-in Partner and another woman outside the focal household. The unfilled circles (204 and 208) indicate that these relationships are previous relationships from the Daughter's perspective.

As shown at 212, the filled circle labeled as “N₄(s)₃” represents a current unmarried relationship of the Mother and the father of the 12-year-old half-sister (d)₅. This relationship 212 includes a son (s)₃. The son (s)₃ is the child of the mother of relationship 208 labeled as “N₃,” as shown in FIG. 2 by the values of the child relationship identifier and the relationship identifier, respectfully associated with the son (s)₃ and the household N₃ both being equal to 3. This is a current relationship from the Daughter's perspective, as indicated with a filled circle.

As shown at 206, the unfilled circle labeled as “N₅” represents the previous relationship of Mother and the father of the 12-year-old half sister (d)₅. As shown at 210, the unfilled circle labeled as “N₆” represents the previous relationship of the Mother and another man who is the father of Daughter.

FIG. 2 shows the relation of each of the parents in the past and in the present. Two filled circles (202 and 212) show current paired relations. The affinograph also shows currently unattached past partners in relations N₂ and N₅, shown at 204 and 206, respectively. Finally, female intragenerational paths from one relationships to another are shown at 205, 211 and 213, and male intragenerational paths from one relationships to another are shown at 203, 207 and 209.

Tracking of persons can be complex even when all past and present relations are marital. The following case of a “blended family” illustrates how people marrying for the first time become involved in complex intragenerational networks.

VI. Tracking Members of a “Blended Family”

Labels such as “blended family,” “compound family,” “melded family,” “reconstituted family” and “multinuclear family” encompass the variety of family structures found in America today. But these labels are imprecise. One dictionary of sociology claims that divorce and remarriage yield “three” new family structures: “the dissolution of families through death and divorce results in three additional structures that have important effect on family life.” Others define a family only in terms of positive emotional ties “the people are committed to each other in intimate, personal relationships.” There exists people who at one point fit the conventional definition and then split across several households can remain emotionally tied through conflict and animosity.

Referring to FIG. 3, a graphical depiction of an exemplary affinograph of a “blended family” according to an embodiment of the present invention is shown. This hypothetical blended family structure 300 is from a daughter's (“Daughter”) perspective. In this hypothetical, Daughter is the child of a previous marriage 302, shown as an unfilled circle labeled as “M₁,” of mother (“Jane”) and father (“Jeff”). Jane and Jeff later divorced, as indicated by the unfilled circle 302.

As shown at 304, the filled circle labeled as “M₂” represents a previous married relationship of Tony. He later divorced, as indicated by the unfilled circle 304.

As shown at 310, the filled circle labeled as “M₃(d)₃(s)₂” represents a current married relationship of the former wife of Tony and her current husband. This relationship 310 includes Tony's son (s)₂ and daughter (d)₃ who is the half-sister of Tony's son (s)₂. In this case, the daughter (d)₃ is shown as the daughter of both parents of the relationship 310 by the values of the child relationship identifier and the relationship identifier, respectfully, associated with the daughter (d)₃ and the household M₃, both being equal to 3.

As shown at 306, the unfilled circle with a slash slanted left and labeled as “M₃(d)₃(s)₂” represents a previous married relationship of Jeff and Laura. Laura later died as indicated by the slash slanted left through the circle. The previous marriage 306 includes a daughter (d)₄ and son (S)₄ who are both children of the previous marriage 306.

As shown at 308, the unfilled circle labeled as “M₅” represents a previous marriage involving Jane and Tony. This previous marriage 308 included a son, Matt (s)₅. Jane and Tony later divorced, as indicated by the unfilled circle. Matt (s)₅ currently lives with Jane and Geno in their current marriage 314.

As shown at 312, the unfilled circle labeled as “M₆” represents a previous marriage involving Tony. He later divorced. As shown at 320, the filled circle labeled as “M₇” represents a current marriage involving Tony. Tony had no children in either marriage (312 or 320).

As shown at 316, the unfilled circle labeled as “M₈” represents a previous marriage of Geno. He later divorced, as indicated by the unfilled circle.

As shown at 318, the filled circle labeled as “M₉3(S)₈” represents a current marriage involving the former wife of Geno. This marriage 318 includes Geno's three sons 3(s)₈.

As shown at 314, the filled circle labeled as “M₁₀(d)₁(S)₅” represents a current marriage involving Jane and Geno. This marriage 313 includes Daughter (d)₁ and Matt (s)₅.

Affinographs reveal relations and locate roles even when such roles have not been named yet. For example, FIG. 3 shows a relationship between a step-father of Daughter (d)₁ who is now in relationship 320, whom the Daughter (d)₁ calls “father” and who was replaced with another step-father in her mother's marriage 314. Because such relationships influence the emotional processes of the family, in clinical settings, affinographs help a therapist maintain the continuity of theme from session to session.

The participant in this case, Daughter (d)₁ had ongoing contacts with family members in five different households labeled as M₃, M₄, M₇, M₈ and M₁₀. Her family included three male parents, and half-brothers and half-sisters and mothers of those siblings.

Of course, many families are not as complex as the one in this example. However, where the family relationship is non-traditional, the affinograph provides a more revealing method of imaging and assessing than is known in the prior art.

VII. Representing an Intergenerational Lineage

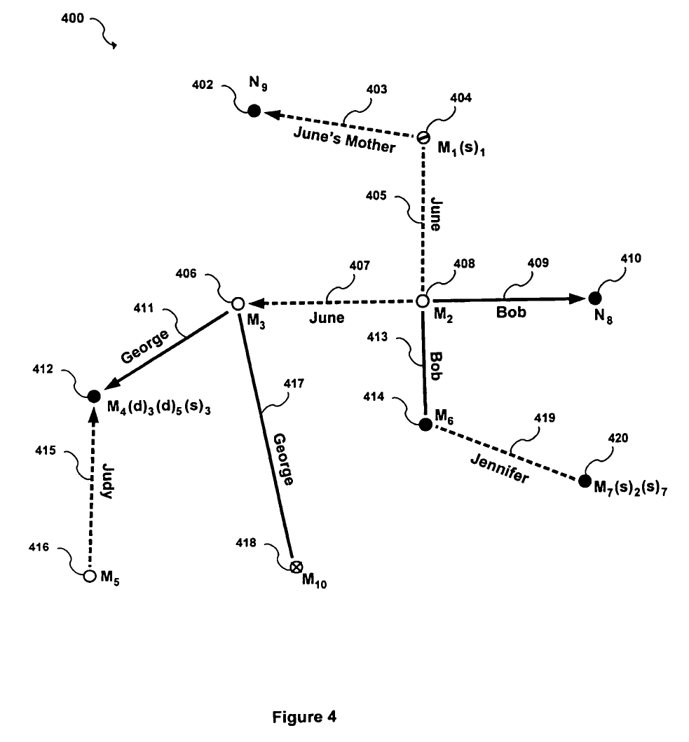

Referring to FIG. 4, a graphical depiction of an exemplary affinograph illustrating an intergenerational lineage according to an embodiment of the present invention is shown. This hypothetical family structure 400 is from a divorced mother's (“June”) perspective. June has 3 children.

As shown at 406, the unfilled circle labeled as “M₂” represents a previous marriage between Bob and June. Bob was June's first husband. The previous marriage 406 included June's oldest child Mat (s)₂. Bob is an alcoholic and June is a recovering alcoholic. As such, Mat (s)₂ was informally adopted by Bob's sister Jennifer who is married to Mark, as shown at 420. Jennifer and Mark have a 5-year-old son, Sam (s)₇.

As shown at 406, the unfilled circle labeled as “M₃” represents a previous marriage between George and June. George was June∝s second husband. The previous marriage 406 included June's two youngest children, Ann (d)₃, a 7-year-old daughter, and John (s)₃, a 4-year-old son.

As shown at 416, the unfilled circle labeled as “M₅” represents the previous marriage of Judy and Pete. As shown at 412, the filled circle labeled as “M₄” represents the current marriage of George and Judy. Pete keeps in touch with his 5-year-old daughter Marry (d)₅ who lives with her mother and George in their marriage 412. As shown at 410, the filled circle labeled as “N₈” represents an unmarried relationship between Bob and his girlfriend.

As shown at 404, the unfilled circle with the slash slanted right and labeled “M₁(s)₁” represents a previous marriage between June's mother and father. The slash slanted right through the circle indicates that the previous marriage 404 ended through the death of June's father. The previous marriage 404 included June and Sam (s)₁. June's father was also an alcoholic and he died at the age of 57. June is having problems with her widowed mother. June's mother never remarried, but she is having an ongoing unmarried relationship 402.

In this hypothetical, the undirected lines (405, 413, 417 and 419) represent intergenerational lineage and the directed lines (403, 407, 409, 411 and 415) represent intragenerational paths from one relationship to another relationship. In particular, undirected line 405 represents June's intergenerational lineage from her parents' previous marriage 404, June's origin, to her first marriage 408. Undirected line 413 represents Bob's intergenerational lineage from his parent's marriage 414, Bob's origin, to his first marriage 408. Undirected line 417 represents George's intergenerational lineage from his parent's marriage 418, Bob's origin, to his first marriage 406. Both of George's parents are deceased, as shown at 418. Finally, undirected line 419 represents Jennifer's intergenerational lineage as Bob's sister.

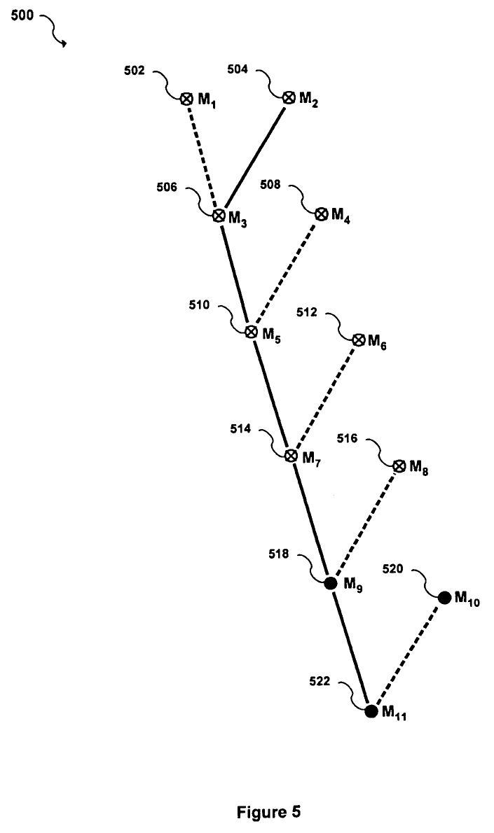

Referring to FIG. 5, a graphical depiction of an exemplary affinograph as an improved family tree according to an embodiment of the present invention is shown. In this hypothetical family tree 500, the intergenerational lineage through marriage over several generations is shown. As shown at 506, the unfilled circle with slashes slanted in both directions and labeled “M₃” represents a previous marriage between a male and a female, both now deceased. The marriages of the parent's of the male and female of the marriage 506 are shown at 504 and 506, respectively. Likewise, the marriages of the parent's of the male and female of the marriage 510 are shown at 506 and 508, respectively. Thus, the female of the marriage 502 is the great grandmother of the male of marriage 514. The unfilled circles with slashes slanted in both directions represent previous marriages (502-516) in which and both parent are now deceased. The filled circles represent current marriages (518-522).

An advantage of using an affinograph family tree over a traditional family tree is its ability to represent more family information within a reduced space. Unlike traditional family trees which grow geometrically with each new level, the affinograph family tree grows linearly. As such, the affinograph family tree is capable of representing substantially more information within the same space as a traditional family tree.

Referring to FIG. 6, a graphical depiction of an exemplary affinograph as an improved family tree according to an alternate embodiment of the present invention is shown. In this embodiment, rectangles are used instead of circles to represent relationships (602-618). General information regarding the family relationship may be recorded within each rectangle including but not limited to the full name, maiden name, age, date of birth, and date of death for each of the family members. Optionally, clinical notes may also be recorded within the rectangles. Obviously, many other shapes (other than circles and rectangles) may be used to represent relationships within the scope of the present invention.

VIII. Conclusion

Considering the prevalence of complex serial relations, there are some compelling reasons for the use of the affinograph method of family imaging for family research and clinical applications. In clinical assessment, an affinograph can help a therapist assess a family when a genogram may not be flexible enough to be useful. In social work, it is clear that an improved method of record keeping could result in a more efficient tracking of children. Tracking could improve in general, because an affinograph focuses on relations that clients identify as significant. For many families today, bloodlines are less relevant than intragenerational relationships with lasting ties.

Today all kinds of social scientists, along with mathematicians and physicists, have embraced the structural perspective. The study of social structure has come of age. Family scientists have been among the first to embrace the structural perspective. However, structures used in clinical settings are still based on family trees. Family trees, even when couched in the new terminology of the genograms, are still a remnant of the time when the family structures remained stable and predictable. Because such is no longer the case, it is time to adapt imaging methods congruent with varied and dynamic family structures.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise than as specifically described.

1. A computer system for graphically representing modern family structures, comprising:
one or more processors; and
a computer readable medium connected to the processors, the computer readable medium including processor instructions configured to be read by the processors and thereby cause the processors to:
graphically represent a plurality of family relationship objects, wherein each family relationship includes one or more person objects representing family members; and
graphically connect each family relationship object to one or more other family relationship objects, wherein each family relationship connection connects two family relationship objects and comprises a person object that is common to the two family relationship objects, and each family relationship connection is a non-hierarchical graphical representation of at least one of an intergenerational family connection and a intragenerational family connection.

2. The computer system of claim 1, wherein the family structures are graphically represented as a graph that conforms to the axioms of graph theory.

3. The computer system of claim 2, wherein the family structures are gender and culturally neutral.

4. The computer system of claim 3, wherein the graph is used to assess modern family structures in a clinical setting.

5. The computer system of claim 3, wherein each of the family relationship objects comprises at least one of a strict monogamy relationship, a serial monogamy relationship, a same gender relationship, a male and female relationship, and a polygamy relationship, and wherein the family relationship objects are graphically represented without any apparent bias toward any form of relationship.

6. The computer system of claim 5, wherein the graphical representation of each of the family relationship objects comprises at least one of a circular shape, a rectangular shape, a triangular shape, a square shape, and a diamond shape, and wherein the graphical representation of each of the family relationship connections comprises a line between two family relationship objects.

7. The computer system of claim 6, wherein the graphical representation of each of the family relationship objects comprises a circular shape.

8. The computer system of claim 7, wherein the graphical representation of each of the family relationship connections comprises at least one of a dotted line and a solid line.

9. The computer system of claim 8, wherein each dotted line represents a female person object, and each solid line represents a male person object.

10. The computer system of claim 8, wherein the graphical representation of each of the family relationship connections comprises at least one of a directed line and an undirected line.

11. The computer system of claim 10, wherein each directed line represents an intragenerational family relationship connection, and each undirected line represents an intergenerational family relationship connection.

12. The computer system of claim 7, wherein the graphical representation of each of the family relationship objects comprises at least one of a filled circular shape and an unfilled circular shape.

13. The computer system of claim 12, wherein each unfilled circular shape represents a previous family relationship object, and each filled circular shape represents a current family relationship object.

14. The computer system of claim 13, wherein one or more of the unfilled circular shapes include at least one of a left slanted slash and a right left slanted slash.

15. The computer system of claim 13, wherein one or more of the unfilled circular shapes include a left slanted slash representing a deceased female partner.

16. The computer system of claim 13, wherein one or more of the unfilled circular shapes include a right slanted slash representing a deceased male partner.

17. The computer system of claim 13, wherein one or more of the unfilled circular shapes include a pair of slashes comprising a right slanted slash and a left slanted slash.

18. The computer system of claim 17, wherein each pair of slashes represents deceased male and female partners.

19. The computer system of claim 13, wherein one or more of the circular shapes include at least one of a pair of parallel left slanted slashes and a pair of parallel right left slanted slashes.

20. The computer system of claim 19, wherein each pair of parallel left slanted slashes represents a pair of deceased female partners, and each pair of parallel left slanted slashes represents a pair of deceased male partners.

21. A method for assessing modern family structures, comprising:
graphically representing a plurality of family relationship objects, wherein each family relationship includes one or more person objects representing family members; and
graphically connecting each family relationship object to one or more other family relationship objects, wherein each family relationship connection connects two family relationship objects and comprises a person object that is common to the two family relationship objects, and each family relationship connection is a non-hierarchical graphical representation of at least one of an intergenerational family connection and a intragenerational family connection.

22. The method of claim 21, wherein the family structures are graphically represented as a graph that conforms to the axioms of graph theory.

23. The method of claim 22, wherein the family structures are gender and culturally neutral.

24. The method of claim 23, wherein the graph is used to assess modern family structures in a clinical setting.

25. The method of claim 23, wherein each of the family relationship objects comprises at least one of a strict monogamy relationship, a serial monogamy relationship, a same gender relationship, a male and female relationship, and a polygamy relationship, and wherein the family relationship objects are graphically represented without any apparent bias toward any form of relationship.

26. The method of claim 25, wherein the graphical representation of each of the family relationship objects comprises at least one of a circular shape, a rectangular shape, a triangular shape, a square shape, and a diamond shape, and wherein the graphical representation of each of the family relationship connections comprises a line between two family relationship objects.

27. The method of claim 26, wherein the graphical representation of each of the family relationship objects comprises a circular shape.

28. The method of claim 27, wherein the graphical representation of each of the family relationship connections comprises at least one of a dotted line and a solid line.

29. The method of claim 28, wherein each dotted line represents a female person object, and each solid line represents a male person object.

30. The method of claim 28, wherein the graphical representation of each of the family relationship connections comprises at least one of a directed line and an undirected line.

31. The method of claim 30, wherein each directed line represents an intragenerational family relationship connection, and each undirected line represents an intergenerational family relationship connection.

32. The method of claim 27, wherein the graphical representation of each of the family relationship objects comprises at least one of a filled circular shape and an unfilled circular shape.

33. The method of claim 32, wherein each unfilled circular shape represents a previous family relationship object, and each filled circular shape represents a current family relationship object.

34. The method of claim 33, wherein one or more of the unfilled circular shapes include at least one of a left slanted slash and a right left slanted slash.

35. The method of claim 33, wherein one or more of the unfilled circular shapes include a left slanted slash representing a deceased female partner.

36. The method of claim 33, wherein one or more of the unfilled circular shapes include a right slanted slash representing a deceased male partner.

37. The method of claim 33, wherein one or more of the unfilled circular shapes include a pair of slashes comprising a right slanted slash and a left slanted slash.

38. The method of claim 37, wherein each pair of slashes represents deceased male and female partners.

39. The method of claim 33, wherein one or more of the circular shapes include at least one of a pair of parallel left slanted slashes and a pair of parallel right left slanted slashes.

40. The method of claim 39, wherein each pair of parallel left slanted slashes represents a pair of deceased female partners, and each pair of parallel left slanted slashes represents a pair of deceased male partners.

41. A method for an improved family tree, comprising:
graphically adding a plurality of family relationship objects to a family tree, wherein each family relationship includes one or more person objects representing family members, each family relationship addition represents a linear growth to the family tree; and
graphically connecting each family relationship object to one or more other family relationship objects, wherein each family relationship connection connects two family relationship objects and comprises a person object that is common to the two family relationship objects, and each family relationship connection is a non-hierarchical graphical representation of at least one of an intergenerational family connection and a intragenerational family connection.
